(19) United States
(12) Patent Application Publication
(10) Pub. No.: US 2024/0253531 A1
(43) Pub. Date: Aug. 1, 2024

(54) METHOD FOR PRODUCING AN ACTUATING LEVER FOR A LONGITUDINAL ADJUSTER, AND ACTUATING LEVER, LONGITUDINAL ADJUSTER, AND VEHICLE SEAT

(71) Applicant: Adient US LLC, Plymouth, MI (US)

(72) Inventors: Joachim FLICK, Hückeswagen (DE); Erik SPRENGER, Wermelskirchen (DE)

(73) Assignee: Adient US LLC, Plymouth, MI (US)

(21) Appl. No.: 18/566,722

(22) PCT Filed: Jun. 15, 2022
(86) PCT No.: PCT/IB2022/055527

§ 371 Date: Dec. 4, 2023

(30) Foreign Application Priority Data
Jun. 18, 2021 (DE) 10 2021 115 781.1
Sep. 1, 2021 (DE) 10 2021 122 623.6

(51) Int. Cl. B60N 2/08; B21D 7/06; B21D 53/88; B60N 2/07

(52) U.S. Cl. CPC B60N 2/0818; B21D 7/06; B21D 53/88; B60N 2/07

(57) ABSTRACT

A method for producing an activation lever for a longitudinal adjuster involves providing a tubular blank, pressing an end portion of the blank from a first direction and pressing the end portion of the blank from a second direction perpendicular to the first direction, whereby only forming of the external contour of the blank takes place. An activation lever for activating a locking unit for securing a first seat rail relative to a second seat rail where the activation lever, in an end portion interacts with a spring element and/or a locking element of the longitudinal adjuster, has a deformed surface which is closed perpendicularly to the longitudinal extent of the activation lever. A longitudinal adjuster for a vehicle seat has the activation lever.

The invention relates to a method for producing an activation lever for a longitudinal adjuster, and to an activation lever, a longitudinal adjuster and a vehicle seat.

### PRIOR ART

A longitudinal adjuster for a vehicle seat is known from WO 2016/091614 A1, having at least one pair of rails comprising a lower rail and an upper rail which is longitudinally displaceable relative to the lower rail, having at least one locking unit for securing the upper rail relative to the lower rail, and at least one activation element for releasing the securing of the upper rail relative to the lower rail, wherein the locking unit comprises at least one locking element and at least one spring element which operatively engage in one another, wherein the spring element is connected in a form-fitting and force-fitting manner to the upper rail by a plug-and-latch connection, and wherein the spring element impinges the activation element and the locking element with a pre-loading force.

### Object

The invention is based on the object of providing an improved method for producing an activation lever for a longitudinal adjuster, in particular of reducing the number of forming process steps. It is furthermore an object of the invention to improve an activation lever for a longitudinal adjuster, and a longitudinal adjuster of the type mentioned at the outset, in particular to provide an activation lever and a longitudinal adjuster which are more economical to produce, and to provide a corresponding vehicle seat.

### Achievement

This object is achieved according to the invention by a method for producing an activation lever for a longitudinal adjuster, the method comprising the following steps:
a) providing a tubular blank;
b) pressing a first end portion of the blank from a first direction;
c) pressing the first end portion of the blank from a second direction, preferably perpendicular to the first direction;
   whereby, in particular, only forming of the external contour of the blank takes place in the method.

As a result of the fact that only forming of the external contour of the blank takes place and cutting process are avoided in particular, an originally closed surface of a blank remains continuously closed even after having been pressed once or multiple times from different directions.

“Only forming” in the context of the invention refers to methods in which blanks made of plastic materials such as, for example, metals, are re-shaped in a targeted manner without removing material from the blanks in the process (such as when cutting) or adding material thereto (such as when joining).

The blank can be a cut-to-length blank. The blank can have a predefined length.

For example, the blank can be pressed and formed from a direction aligned parallel to a transverse direction of extent of the activation lever.

For example, the blank can be pressed and formed from a direction aligned parallel to a vertical direction of extent of the activation lever.

The underlying object is furthermore achieved according to the invention by an activation lever for activating a locking unit for securing a first seat rail relative to a second seat rail, wherein the activation lever in an end portion interacting with a spring element and/or locking element of the longitudinal adjuster has a deformed surface which is closed perpendicularly to the longitudinal extent of the activation lever.

As a result of the fact that the activation lever in an end portion interacting with a spring element and/or a locking element of the longitudinal adjuster has a deformed—and closed surface, the activation lever has increased strength and can be more rapidly produced in fewer operating steps.

The activation lever can have two activation portions which are integrally connected to one another by way of a connection portion. The connection portion can furthermore serve as a handle for an occupant of a vehicle seat. The two activation portions can run substantially parallel to the longitudinal direction along an internal duct between a respective first seat rail and second seat rail.

The underlying object is furthermore achieved according to the invention by a longitudinal adjuster for a vehicle seat, the longitudinal adjuster having at least one first seat rail and one second seat rail, the first seat rail being longitudinally displaceable relative to the second seat rail; the longitudinal adjuster furthermore having a locking unit which has at least one locking element for securing the first seat rail relative to the second seat rail, and at least one spring element which is held in the first seat rail and impinges the locking element with a pre-loading force; wherein the longitudinal adjuster has a previously described activation lever for activating the locking unit, in particular for releasing the securing of the first seat rail relative to the second seat rail, and the activation lever is impinged with a pre-loading force by the spring element.

The first seat rail can be a first seat rail fixed to the seat. The second seat rail can be a second seat rail fixed to the vehicle. The first seat rail and the second seat rail can embrace one another. The longitudinal adjuster can have two first seat rails and two second seat rails which are disposed in pairs. Here, one first seat rail and one second seat rail can in each case be disposed so as to be longitudinally displaceable in relation to one another and embrace one another while forming an internal duct.

The locking element can be designed as a latching plate having lateral tooth-shaped latching moldings for securing the first seat rail relative to the second seat rail. The spring element can impinge the locking element in the direction of a locking position in which a displacement capability of the first seat rail relative to the second seat rail is locked. The activation lever can be impinged in the direction of a normal position in which the damping element bears on the first seat rail in the vertical direction from below.

The spring element can be configured as a leaf spring. The spring element can have a holding portion, a first spring arm, and a second spring arm. The spring arms can project from the holding portion. The spring element can be held on the first seat rail by the holding portion. The holding portion can have a through-opening.

The activation lever can be disposed on the spring element in such a manner that the activation lever is mounted as a rocker. The activation portion of the activation lever can be disposed in the through-opening of the spring element in such a manner that the activation lever is mounted as a rocker.

The activation portion of the activation lever can be guided through the through-opening. The activation portion can have lateral detents in the region of the through-opening so as to define and stabilize a position of the activation portion in the spring element.

If the respective end portion having the damping element is moved in the direction of an unlocking position when the activation lever is activated for unlocking the longitudinal adjuster, the locking element in the unlocking position can release a displacement capability of the first seat rail relative to the second seat rail.

The end portion having the damping element can be disposed between the first seat rail and the locking element. The locking element can comprise a guide pin which protrudes upward in the vertical direction and which is able to be guided through an opening in the first seat rail.

The activation lever can have a back-molding on the end portion. The back-molding can serve for fastening the damping element to the activation lever. The damping element can have a corresponding counter-element which engages behind the back-molding and holds the damping element on the activation lever. The back-molding is generated by reducing a material cross section. The back-molding can be configured on a lower side of the activation lever. The back-molding can protrude from the lower side of the activation lever. The end portion can be pressed and formed in an upward manner such that the back-molding projects downward. The damping element is attached to and/or pushed onto the back-molding. In the assembled state, the damping element can engage in a latching manner on the end portion of the activation lever. The damping element cannot slide back off the end portion in a self-acting manner. The counter-element of the damping element can engage behind the back-molding.

The first spring arm can exert substantially a spring force on the activation portion of the activation lever. The spring force of the first spring arm can act upward in the vertical direction. A preload of the activation lever generated by the spring force of the first spring arm can keep said activation lever in the normal position, in which the locking element is in a locking position. In the locking position, the lateral latching moldings can be operatively engaged with latching clearances disposed in the second seat rail.

The second spring arm can exert substantially a spring force on the locking element, the spring force impinging the locking element in the direction of a locking position. The spring force of the second spring arm can act upward in the vertical direction.

The first seat rail can have a horizontally running base and two legs which each protrude laterally downward from the base and have peripheral regions bent outward. “Peripheral regions” refers generally to sub-portions of a profile of the first seat rail that are bent laterally outward, parallel to the transverse direction, and bent upward and are shaped by multiple bending operations.

In the normal position of the activation lever, the damping element can be in contact with the base. The activation lever can have an end portion which interacts with a spring element and/or a locking element of the longitudinal adjuster and has a deformed surface that is closed perpendicularly to the longitudinal extent of the activation lever.

The activation lever can have an activation portion, a damping element being able to be disposed on the end portion thereof. A plurality of corrugations can be disposed in the region of the activation portion. The corrugations can serve as local reinforcements of the activation portion. The corrugations can offer the additional advantage that material in the region of the activation portion is formed exclusively when pressing the end portion, this rendering the otherwise necessary removal of the material avoidable.

An edge which is shaped by pressing the end portion can be provided on the activation portion. The edge can serve as an operative connection to the first spring arm. The edge can support the first spring arm. The edge is generated by reducing a material cross section. The edge can be configured on a lower side of the activation lever, in particular of the activation portion. The edge can protrude from the lower side of the activation lever. The end portion can be pressed and formed upward in such a manner that the edge projects downward.

The end portion of the activation portion of the activation lever can have only a crease by way of which the end portion tapers without causing any weakening of the material by cutting or blanking.

A free end of the end portion can have an end-side opening within the attached damping element. The activation lever can be designed to be hollow.

The underlying object is furthermore achieved according to the invention by a vehicle seat having a previously described longitudinal adjuster according to the invention.

The vehicle seat can have a seat part. The vehicle seat can have a backrest. The backrest of the vehicle seat can be adjustable for rake in relation to the seat part. The seat part can be connected to the longitudinal adjuster. A seat height adjustment linkage can be provided for connecting the seat part to the longitudinal adjuster.

Advantageous design embodiments which may be used individually or in combination with one another are the subject matter of the dependent claims.

In summary, and in other words, it is advantageous according to the invention for the geometry of the at least one end portion of the activation lever to be designed in such a manner that the tubular cross section is not cut into or cut off, but, rather, the required geometry is able to be generated by an in particular single-stage forming process in two directions oriented so as to be mutually perpendicular (in the vertical direction and the transverse direction). The end portion of the activation lever is preferably designed in such a manner that the required damper can be pushed on and cannot slide off again in a self-acting manner owing to an undercut (reduced material cross section). The end portion of the activation lever and of the damper is preferably designed in such a manner that the activation lever having the assembled damper is able to be guided through and assembled through an opening in the spring. Accordingly, the primary material of the tube has to be able to be received in each cross section by forming procedures or folding procedures.

### FIGURES AND EMBODIMENTS OF THE INVENTION

Prior to describing design embodiments of the invention in more detail with the aid of drawings hereunder, it is to be noted firstly that the invention is not limited to the components described or the method steps described. Furthermore, the terminology used also does not imply any limitation but is merely exemplary. If the singular is used in the description and the claims hereunder, the plural is in each case included unless explicitly excluded by the context.

The invention is explained in more detail hereunder with the aid of an advantageous exemplary embodiment illustrated in the figures. However, the invention is not limited to this exemplary embodiment. In the figures:

FIG. 1: shows a vehicle seat according to the invention;

FIG. 2: shows a longitudinal adjuster according to the invention for a vehicle seat;

FIG. 3: schematically shows a longitudinal section through the longitudinal adjuster of FIG. 2;

FIG. 4: schematically shows a cross section through the longitudinal adjuster of FIG. 2, along the section line IV-IV;

FIG. 5: schematically shows a cross section through the longitudinal adjuster of FIG. 2, along the section line V-V;

FIG. 6: shows in portions and in an exploded illustration an activation lever known from the prior art and a damping element;

FIG. 7: shows in portions and in an exploded illustration an activation lever according to the invention and a damping element; and

FIG. 8: shows in portions the activation lever from FIG. 7, having an assembled damping element.

### EQUIVALENT PARTS ARE PROVIDED WITH THE SAME REFERENCE SIGNS IN ALL FIGURES

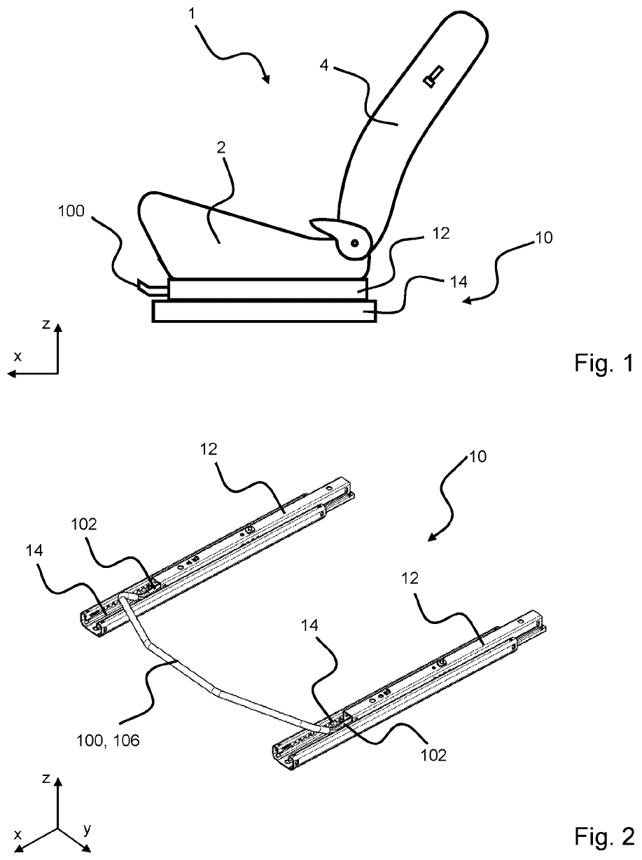

A vehicle seat 1, schematically illustrated in FIG. 1, will be described hereunder using three spatial directions which run so as to be mutually perpendicular. In a vehicle seat 1 installed in the vehicle, a longitudinal direction x runs largely horizontally and preferably parallel to a vehicle longitudinal direction which corresponds to the usual direction of travel of the vehicle. A transverse direction y, running perpendicularly to the longitudinal direction x, is likewise horizontally aligned in the vehicle and runs parallel to a vehicle transverse direction. A vertical direction z runs perpendicularly to the longitudinal direction x and perpendicularly to the transverse direction y. In a vehicle seat 1 installed in the vehicle, the vertical direction z runs parallel to the vehicle vertical axis.

The positional indicators and directional indicators used, such as front, rear, top and bottom, for example, relate to a direction of view of an occupant seated in a normal sitting position in the vehicle seat 1, the vehicle seat 1 being installed in the vehicle and being in a use position suitable for transporting passengers, with an upright backrest 4, and being aligned in a customary manner in the direction of travel. The vehicle seat 1 according to the invention may however also be installed in an alignment deviating therefrom, for example transversely to the direction of travel.

The vehicle seat 1 has a seat part 2. The backrest 4 of the vehicle seat 1 is held on the seat part 2 so as to be adjustable for rake. The vehicle seat 1 has a longitudinal adjuster 10. The seat part 2 is connected to the longitudinal adjuster 10. A seat height adjustment linkage can be provided for connecting the seat part 2 to the longitudinal adjuster 10.

FIG. 2 shows the longitudinal adjuster 10 of the vehicle seat 1. The longitudinal adjuster 10 has at least one first seat rail 12 which is in particular fixed to the seat, and a second seat rail 14 which is in particular fixed to the vehicle, the first seat rail 12 being longitudinally displaceable relative to the second seat rail 14. The first seat rail 12 and the second seat rail 14 embrace one another. The longitudinal adjuster 10 presently has two first seat rails 12 and two second seat rails 14 which are disposed in pairs, one first seat rail 12 and one second seat rail 14 being in each case disposed so as to be mutually displaceable longitudinally and embracing one another while forming an internal duct. The longitudinal adjuster 10 has an activation lever 100 for releasing a securing of the first seat rail 12 relative to the second seat rail 14. The activation lever 100 is largely U-shaped. The activation lever 100 presently has two activation portions 102 which are integrally connected to a connection portion 106. The connection portion 106 furthermore serves as a handle for releasing the securing action by an occupant of the vehicle seat 1. The two activation portions 102 run substantially parallel to the longitudinal direction x, at least in portions along the internal duct between a respective first seat rail 12 and second seat rail 14.

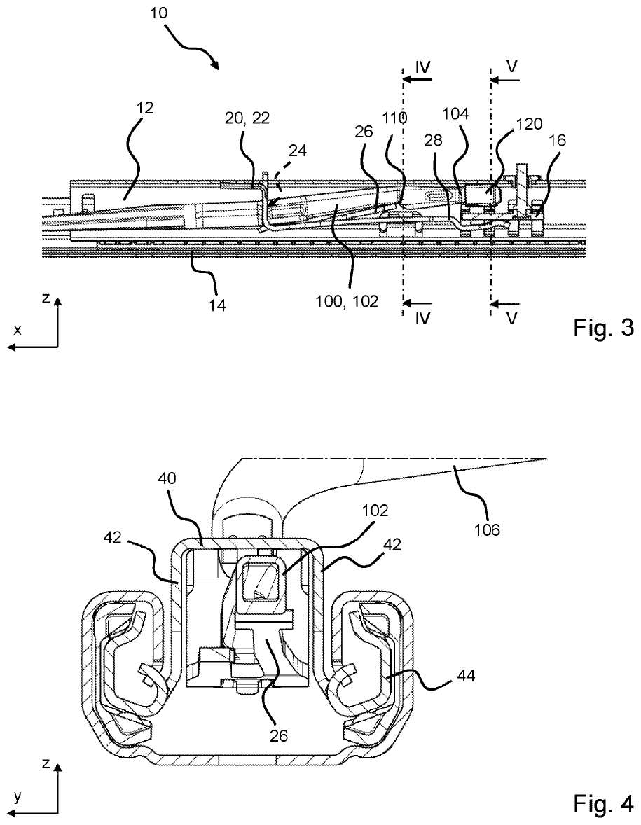

FIG. 3 shows a longitudinal section through the longitudinal adjuster 10 of FIG. 2. The longitudinal adjuster 10 has at least one locking element 16 for securing the first seat rail 12 relative to the second seat rail 14, and at least one spring element 20 which is held in the first seat rail 12 and which impinges the locking element 16 with a pre-loading force. The locking element 16 is presently designed in the form of a latching plate having lateral tooth-shaped latching moldings for securing the first seat rail 12 relative to the second seat rail 14. The spring element 20 impinges the locking element 16 in the direction of a locking position in which a displacement capability of the first seat rail 12 relative to the second seat rail 14 is locked. The activation lever 100 is impinged with a pre-loading force by the spring element 20. The activation lever 100 is preferably impinged in the direction of a normal position in which a damping element 120 bears on the first seat rail 12 in the vertical direction z from below.

The spring element 20 is presently configured as a leaf spring. The spring element 20 has a holding portion 22, a first spring arm 26, and a second spring arm 28. The spring arms 26, 28 project from the holding portion 22. The spring element 20 is held on the first seat rail 12 by the holding portion 22. The holding portion 22 has a through-opening 24.

The activation lever 100, in particular the activation portion 102 of the activation lever 100, is disposed on the spring element 20, in particular in the through-opening 24, in such a manner that the activation lever 100 is mounted as a rocker. The activation portion 102 of the activation lever 100 is guided through the through-opening 24. Furthermore, the activation portion 102 has lateral detents in the region of the through-opening 24 so as to define and stabilize a position of the activation portion 102 in the spring element 20.

If the respective end portion 104 having the damping element 120 is moved in the direction of an unlocking position when the activation lever 100 is activated for unlocking the longitudinal adjuster 10, the locking element 16 in the unlocking position releases a displacement capability of the first seat rail 12 relative to the second seat rail 14.

The end portion 104 having the damping element 120 is disposed between the first seat rail 12 and the locking element 16. The locking element 16 furthermore comprises a guide pin which protrudes upward in the vertical direction z and which is guided through an opening in the first seat rail 12.

The first spring arm 26 exerts a spring force on the activation portion 102 of the activation lever 100. The spring force of the first spring arm 26 presently acts upward in the vertical direction z. A preload of the activation lever 100 generated by the spring force of the first spring arm 26 keeps said activation lever 100 in the normal position, in which the locking element 16 is in a locking position. In the locking position, the lateral latching moldings operatively engage with latching clearances disposed in the second seat rail 14.

The second spring arm 28 exerts a spring force on the locking element 16, the spring force impinging the locking element 16 in the direction of a locking position. In the present context, the spring force of the second spring arm 28 acts upward in the vertical direction z.

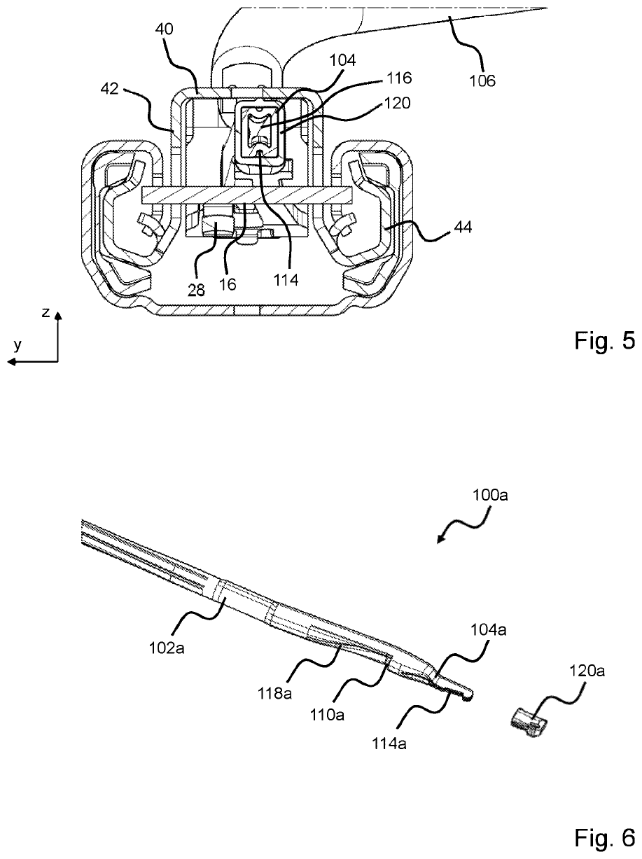

FIGS. 4 and 5 show in each case a cross section through the longitudinal adjuster 10 along the section lines IV-IV and V-V from FIG. 3, respectively. The first seat rail 12 has a substantially horizontally running base 40 and two legs 42 which each protrude laterally downward from the base 40 and have peripheral regions 44 bent outward. “Peripheral regions” 44 refers generally to sub-portions of the profile that are bent laterally outward, parallel to the transverse direction y, and bent upward and are shaped by multiple bending operations. In the normal position of the activation lever 100, the damping element 120 is in contact with the base 40.

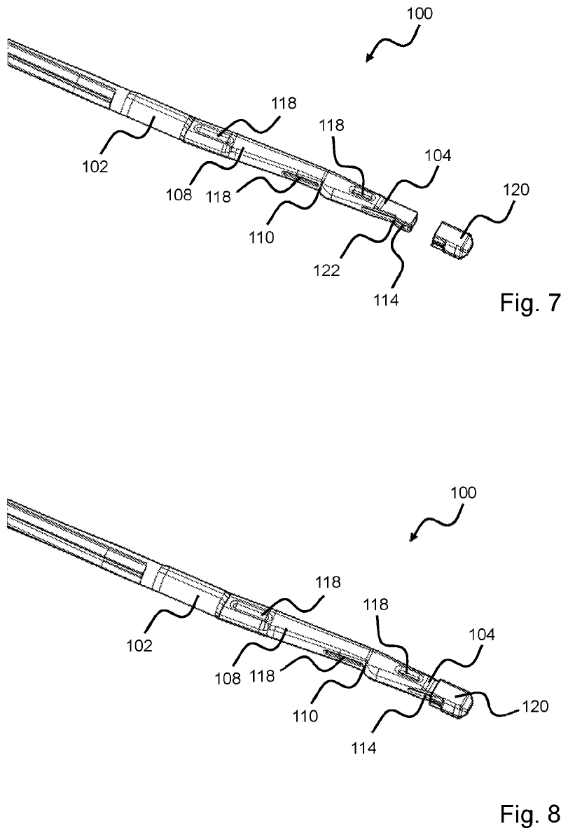

As is illustrated in FIGS. 7 and 8, the activation lever 100 has an end portion 104 which interacts with a spring element 20 and/or a locking element 16 of the longitudinal adjuster 10 and has a deformed surface 108 that is closed perpendicularly to the longitudinal extent of the activation lever 100.

FIG. 6 shows in portions an activation lever 100a, known from the prior art, having a damping element 120a.

The activation lever 100a has an activation portion 102a, a damping element 120a being able to be disposed on the end portion 104a thereof. A crease 118a having an adjacent sharp edge 110a is shaped in the region of the activation portion 102a, said crease 118a being formed by blanking or cutting portions of the latter and subsequently folding said portions inward. The end portion 104a of the activation portion 102a has blanked or cut ends 114a which for the purpose of tapering the end portion 104a are bent onto one another in such a manner that the two cut ends 114a rest on one another.

FIGS. 7 and 8 show in portions an activation lever 100 according to the invention, having a damping element 120. The activation lever 100 has an activation portion 102, a damping element 120 being able to be disposed on the end portion 104 thereof. The activation lever 100 has a back-molding 122 on the end portion 104. The back-molding 122 protrudes downward in the vertical direction z. Alternatively, the back-molding 122 may protrude upward. The back-molding 122 can be shaped by pressing the end portion 104 in the vertical direction z, for example. The back-molding 122 serves for fastening the damping element 120 to the activation lever 100. The damping element 120 has a corresponding counter-element which engages behind the back-molding 122 and holds the damping element 120 on the activation lever 100. The damping element 120 is connected to the end portion 104 at least in a force-fitting and/or form-fitting manner. The counter-element can be configured to be reversibly flexible. The counter element can have a spring force and/or tensioning force directed inward into a receptacle space of the damping element 120. The receptacle space can be a cavity configured in the damping element 120, the end portion 104 being able to be introduced or inserted into said cavity. A plurality of corrugations 118 are disposed in the region of the activation portion 102. The corrugations 118 serve as local reinforcements of the activation portion 102. The corrugations 118 have the additional advantage that material in the region of the activation portion 102 is able to be exclusively moved when pressing the end portion 104, this avoiding the otherwise necessary removal of the material.

On the activation portion 102 there is an edge 110 which has been shaped by pressing the end portion 104. A circumferential surface 108, in particular a shell face, of the end portion 104 on the activation portion 102 is continuously closed. The edge 110 protrudes downward in the vertical direction z. The edge 110 is provided to come to bear on the upward-projecting spring arm 26. The edge 110 can be shaped by pressing the end portion 104 in the vertical direction z, for example. The closed circumferential surface 108 means that no separating methods, punching methods or cutting methods whatsoever are used, or no openings in the surface 108 whatsoever are configured, as a result of forming the end portion 104 by pressing.

In contrast to the end portion 104a of the activation portion 102a of the activation lever 100a, the end portion 104 of the activation portion 102 of the activation lever 100 has no blanked or cut ends 114a, but only a crease 114 by way of which the end portion 104 is likewise able to be tapered without causing any weakening of the material by cutting or blanking. An originally closed surface of a blank remains continuously closed even after having been pressed once or multiple times from different directions. The material of the activation lever 100 is only formed.

A free end of the end portion 104 has an end-side opening 116 within the attached damping element 120.

The features disclosed in the above description, in the claims and in the drawings may be of significance both individually and in combination for the realization of the invention in its various embodiments.

Even though the invention has been described in detail in the drawings and in the above presentation, the statements are to be understood as being illustrative, exemplary, and non-restrictive. In particular, the selection of the proportions of the individual elements illustrated in the drawing is not to be interpreted as being necessary or restrictive. Furthermore, the invention is in particular not restricted to the exemplary embodiments discussed. Further variants of the invention and of the embodiment thereof emerge to a person skilled in the art from the preceding disclosure, from the figures and from the claims.

Terms such as “comprise”, “have”, “contain”, “encompass” and the like used in the claims do not rule out further elements or steps. The use of the indefinite article does not rule out a multiplicity. A single device may perform the functions of several of the units or devices mentioned in the claims.

### LIST OF REFERENCE SIGNS

1 Vehicle seat
2 Seat part
4 Backrest
Longitudinal adjuster
12 First seat rail
14 Second seat rail
16 Locking element
Spring element
22 Holding portion
24 Through-opening
26 First spring arm
28 Second spring arm
Base
42 Leg
44 Peripheral regions
100, 100a Activation lever
102, 102a Activation portion
104, 104a End portion
106 Connection portion
108 Surface
110, 110a Edge
114 Crease
114a Cut end
116 Opening
118 Corrugation
118a Crease
120, 120a Damping element
122 Back-molding
x Longitudinal direction
y Transverse direction
z Vertical direction

1-10. (canceled)

11. A method for producing an activation lever for a longitudinal adjuster, the method comprising:
providing a tubular blank;
pressing an end portion of the blank from a first direction;
pressing the end portion of the blank from a second direction, perpendicular to the first direction, whereby at least one edge and/or a back-molding is formed, and
whereby only forming of the external contour of the blank takes place.

12. An activation lever for activating a locking unit for securing a first seat rail relative to a second seat rail,
wherein the activation lever, in an end portion interacting with a spring element and/or locking element of the longitudinal adjuster, has a deformed surface which is closed perpendicularly to the longitudinal extent of the activation lever, the end portion having at least one back-molding, at least one damping element being disposed on the end portion and connected to the back-molding.

13. The activation lever as claimed in claim 12, the activation lever having two activation portions which are integrally connected to one another by way of a connection portion.

14. The activation lever as claimed in claim 12, wherein an edge which is formed by pressing the end portion is provided on the activation portion.

15. The activation lever as claimed in claim 14, wherein the edge serves as an operative connection to a first spring arm of a spring element.

16. The activation lever as claimed in claim 14, wherein the edge is configured to protrude in the vertical direction from the activation portion.

17. The activation lever as claimed in claim 12, wherein the back-molding protrudes in the vertical direction from the end portion.

18. A longitudinal adjuster for a vehicle seat, the longitudinal adjuster having the first seat rail and the second seat rail, the first seat rail being longitudinally displaceable relative to the second seat rail; the longitudinal adjuster furthermore having the locking unit which has the at least one locking element for securing the first seat rail relative to the second seat rail, and the at least one spring element which is held in the first seat rail and impinges the locking element with a pre-loading force, wherein
the longitudinal adjuster has an activation lever, as claimed in claim 12, for activating the locking unit and releasing the securing of the first seat rail relative to the second seat rail, and the activation lever is impinged with a pre-loading force by the spring element.

19. The longitudinal adjuster as claimed in claim 18, wherein the first seat rail and the second seat rail are disposed to be longitudinally displaceable in relation to one another and embracing one another while forming an internal duct.

20. A vehicle seat having a longitudinal adjuster as claimed in claim 18.
